(19) United States
(12) Patent Application Publication
(10) Pub. No.: US 2025/0363653 A1
(43) Pub. Date: Nov. 27, 2025

(54) DETERMINING REAL-WORLD DIMENSION(S) OF A THREE-DIMENSIONAL SPACE

(71) Applicant: Telefonaktiebolaget LM Ericsson (publ), Stockholm (SE)

(72) Inventors: Elijs DIMA, Upplands Väsby (SE); Volodya GRANCHAROV, Solna (SE)

(73) Assignee: Telefonaktiebolaget LM Ericsson (publ), Stockholm (SE)

(21) Appl. No.: 18/873,013

(22) PCT Filed: Jun. 13, 2022
(86) PCT No.: PCT/EP2022/066050

§ 371 Date: Dec. 9, 2024

(51) Int. Cl. G06T 7/60; G06T 7/593; G06T 7/73; G06T 19/00

(52) U.S. Cl. CPC G06T 7/60; G06T 7/593; G06T 7/73; G06T 19/00; G06T 2200/08; G06T 2207/10012; G06T 2210/04; G06T 2219/012

(57) ABSTRACT

A method (1000) of determining a dimension value indicating a physical dimension of a three-dimensional (3D) space is provided. The method (1000) comprises obtaining (s1002) a first image, wherein the first image is generated using a first lens of a camera, identifying (s!004) a first set of one or more key points included in the first image, and obtaining (s1006) a second image, wherein the second image is generated using a second lens of the camera. The method (1000) further comprises identifying (s1008) a second set of one or more key points included in the second image and determining (S1010) a set of one or more 3D points associated with the first set of key points and the second set of key points, wherein the set of one or more 3D points includes a first 3D point. The method (1000) further comprises calculating (s1012) a first distance value indicating a distance between the camera and a real-world point corresponding to the first 3D point and based at least on the calculated first distance value, determining (s1014) the dimension value.

### TECHNICAL FIELD

Disclosed are embodiments related to methods and apparatus for determining real-world dimension(s) (a.k.a., physical dimension(s)) of a three-dimensional (3D) space.

### BACKGROUND

Today 3D reconstruction of a space is widely used in various fields. For example, for home renovation, one or more 360-degree cameras may be used to capture multiple shots of a kitchen that is to be renovated, and the kitchen may be reconstructed in a 3D virtual space using the captured multiple images. The generated 3D reconstruction of the kitchen can be displayed on a screen and manipulated by a user in order to help the user to visualize how to renovate the kitchen.

### SUMMARY

However, certain challenges exist. For example, generally 360-degree cameras alone cannot determine the real-world dimension(s) of a reconstructed 3D space. Multiple shots of 360 camera(s) may be used to estimate a scene geometry of a reconstructed 3D space but the dimensions of the reconstructed 3D space measured by the camera(s) would be in an arbitrary scale. Knowing only the dimension(s) in an arbitrary scale (a.k.a., “relative dimension(s)) may prevent using the estimated scene geometry for measurement purposes and may complicate comparisons and embeddings of multiple separate reconstructions. Thus, there is a need for a way to measure the real-world dimension(s) (a.k.a., “absolute dimension(s)) of the 3D space.

Accordingly, in one aspect of some embodiments of this disclosure, there is provided a method of determining a dimension value indicating a physical dimension of a three-dimensional, 3D, space. The method comprises obtaining a first image, wherein the first image is generated using a first lens of a camera, identifying a first set of one or more key points included in the first image, and obtaining a second image, wherein the second image is generated using a second lens of the camera. The method further comprises identifying a second set of one or more key points included in the second image, and determining a set of one or more 3D points associated with the first set of key points and the second set of key points, wherein the set of one or more 3D points includes a first 3D point. The method further comprises calculating a first distance value indicating a distance between the camera and a real-world point corresponding to the first 3D point and based at least on the calculated first distance value, determining the dimension value.

In another aspect, there is provided a computer program comprising instructions which when executed by processing circuitry cause the processing circuitry to perform the method of any one of the embodiments described above.

In a different aspect, there is provided an apparatus for determining a dimension value indicating a physical dimension of a three-dimensional, 3D, space. The apparatus is configured to obtain a first image, wherein the first image is generated using a first lens of a camera, identify a first set of one or more key points included in the first image, and obtain a second image, wherein the second image is generated using a second lens of the camera. The apparatus is further configured to identify a second set of one or more key points included in the second image, and determine a set of one or more 3D points associated with the first set of key points and the second set of key points, wherein the set of one or more 3D points includes a first 3D point. The apparatus is further configured to calculate a first distance value indicating a distance between the camera and a real-world point corresponding to the first 3D point, and based at least on the calculated first distance value, determine the dimension value.

In a different aspect, there is provided an apparatus comprising a processing circuitry and a memory, said memory containing instructions executable by said processing circuitry, whereby the apparatus is operative to perform the method of any one of the embodiments described above.

Embodiments of this disclosure allow determining real-world dimension(s) of a reconstructed 3D space without directly measuring the real-world dimension(s) using a depth sensor such as a Light Detection and Ranging (LiDAR) sensor, a stereo camera, or a laser range meter.

The accompanying drawings, which are incorporated herein and form part of the specification, illustrate various embodiments.

### BRIEF DESCRIPTION OF THE DRAWINGS

FIG. 1 shows an exemplary scenario where embodiments of this disclosure are implemented.

FIG. 2 shows a view of an exemplary real-world environment.

FIG. 3 shows an exemplary reconstructed 3D space.

FIG. 4 shows a process according to some embodiments.

FIGS. 5A and 5B show key points according to some embodiments.

FIG. 6 shows 3D points according to some embodiments.

FIG. 7 illustrates a method of aligning two different rotational spaces.

FIG. 8A shows directional vectors according to some embodiments.

FIG. 8B shows a method of determining a physical dimension of reconstructed 3D space according to some embodiments.

FIG. 9 shows a top view of a 360-degree camera according to some embodiments.

FIG. 10 shows a process according to some embodiments.

FIG. 11 shows an apparatus according to some embodiments.

### DETAILED DESCRIPTION

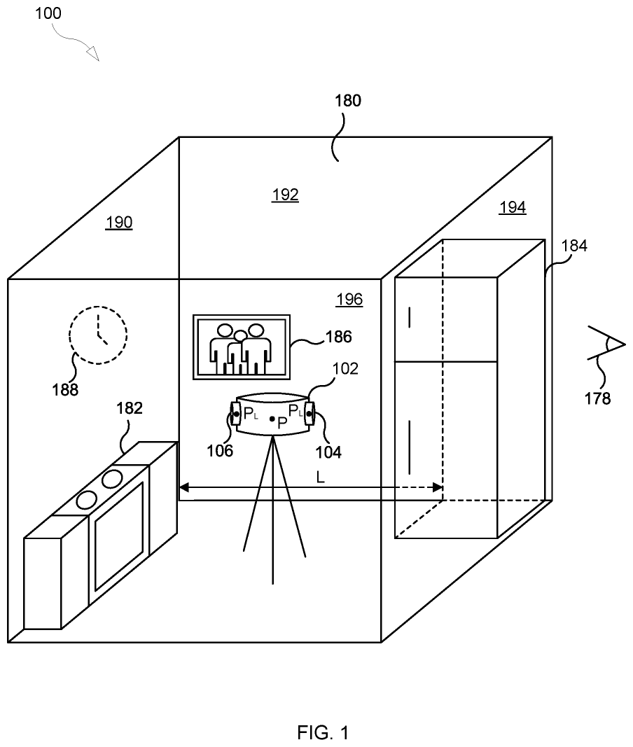

FIG. 1 shows an exemplary scenario 100 where embodiments of this disclosure are implemented. In scenario 100, a 360-degree camera (herein after, “360 camera”) 102 is used to capture a 360-degree view of a kitchen 180. In kitchen 180, an oven 182, a refrigerator 184, a picture frame 186, and a wall clock 188 are located. In this disclosure, a 360 camera is defined as any camera that is capable of capturing a 360-degree view of a scene.

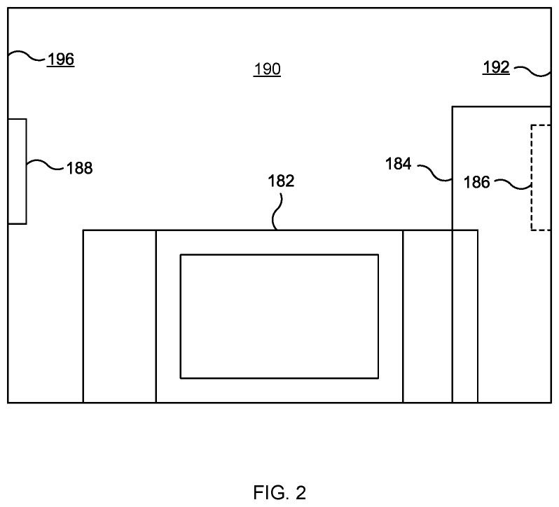

As shown in FIG. 1, oven 182 is placed against a first wall 190, picture frame 186 is placed against a second wall 192, refrigerator 184 is placed against second wall 192 and a third wall 194, and wall clock 188 is placed against a fourth wall 196. FIG. 2 shows a view of kitchen 180 from a view point 178 (indicated in FIG. 1).

Camera 102 may include a first fisheye lens 104 and a second fisheye lens 106. The number of fisheye lenses shown in FIG. 1 is provided for illustration purpose only and does not limit the embodiments of this disclosure in any way.

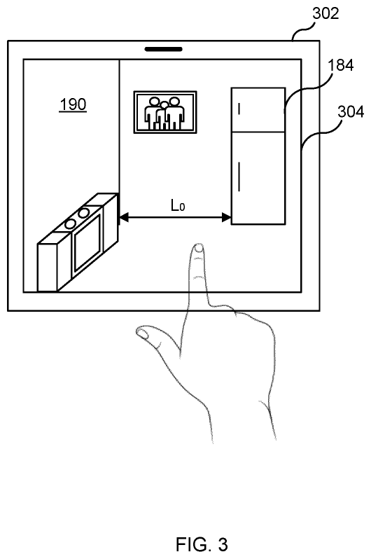

As shown in FIG. 3, the captured 360-degree view of kitchen 180 may be displayed at least partially on a display 304 (e.g., a liquid crystal display, an organic light emitting diode display, etc.) of an electronic device 302 (e.g., a tablet, a mobile phone, a laptop, etc.). Note that even though FIG. 3 shows that only a partial view of kitchen 180 is displayed on display 304, in some embodiments, entire 360-degree view of kitchen 180 may be displayed. Also the curvature of the 360-degree view is not shown in FIG. 3 for simplification purpose.

In some scenarios, it may be desirable to display a real-world length of a virtual dimension (e.g., “L₀”) on display 304 (Note that L₀ shown in FIG. 3 is a length of the dimension in an arbitrary scale). For example, in order to help a user to determine whether a particular kitchen sink will fit into the space between first wall 190 and a left side of refrigerator 184, it may be desirable to show the real-world length of the virtual dimension L₀ on display 304. However, as discussed above, a real-world length of a dimension of a reconstructed 3D space cannot be measured or determined by 360 camera(s) alone.

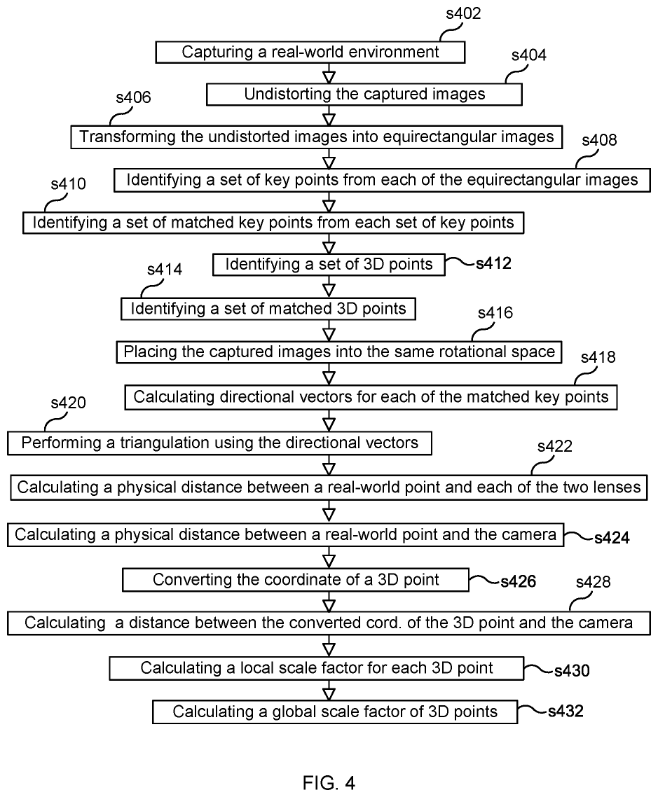

Accordingly, in some embodiments of this disclosure, a process 400 shown in FIG. 4 is performed in order to determine the real-world dimension(s) of the reconstructed 3D space (e.g., kitchen 180). Process 400 may begin with step s402.

Step s402 comprises capturing a real-world environment (a.k.a., “scene”) using first fisheye lens 104 and second fisheye lens 106, thereby obtaining a first fisheye image I_{F1} and a second fisheye image I_{F2}. As noted above, the number of cameras used for capturing the real-world environment is not limited to two but can be any number. Similarly, the number of fisheye images captured by camera 102 and/or the number of fisheye lenes included in camera 102 can be any number.

Step s404 comprises undistorting the first and second fisheye images I_{F1} and I_{F2} using a set (T) of one or more lens distortion parameters. More specifically, in step s404, the first fisheye image I_{F1} is transformed into a first undistorted image—e.g., a first equidistant image I_{FC1}—using the set T and the second fisheye image I_{F2} is transformed into a second undistorted image—e.g., a second equidistant image I_{FC2} using the set T. Equidistant image is a well-known term in the field of computer vision, and thus is not explained in detail in this disclosure.

Description of equidistant image can be found in the following link: https://wiki.panotools.org/Fisheye_Projection.

Step s406 comprises transforming the first undistorted image (e.g., the first equidistant image I_{FC1}) into a first equirectangular image I_{EQN1} and the second undistorted image (e.g., the second equidistant image I_{FC2}) into a second equirectangular image I_{EQN2}. Equirectangular image is an image having a specific format for 360-degree imaging, where the position of each pixel of the image reflects longitude and latitude (a.k.a., azimuth and inclination) angles with respect to a reference point. By definition, an equirectangular image covers 360-degrees (horizontal) by 180 degrees (vertical) in a single image. Like the equidistant image, equirectangular image is a well-known term in the field of computer vision, and thus is not explained in detail in this disclosure.

In some embodiments, instead of converting the first and second fisheye images into the equirectangular images, the first and second fisheye images can be converted into perspective images I_{PE}. Alternatively, the equirectangular images obtained from the first and second fisheye images can be converted into the perspective images. I_{PE} is like a “normal camera image”, in which straight lines of the recorded space remain straight in the image. However, this also means that an I_{PE} cannot fundamentally cover more than 179.9 degrees in a single image, without gross distortion and breaking of the fundamental rule that straight lines must remain straight. In 360-degree cameras, I_{PE} is not typically a “standard” result, however a multitude of computer vision solutions are designed for “standard” cameras and thus work on I_{PE} type images.

On the contrary, I_{EQN} is an “equirectangular image,” a specific format for 360-degree imaging, where the position of each pixel actually reflects the longitude and latitude angles. An I_{EQN} by definition covers 360-degrees (horizontal) by 180 degrees (vertical) in a single image. In some 360-degree cameras, an I_{EQN} centered on the camera body is a “default” output format. An I_{EQN} can be converted into a set of several I_{PE}, in, for example, a cubemap layout (as described in https://en.wikipedia.org/wiki/Cube_mapping).

Referring back to FIG. 4, step s408 comprises identifying a first set of key points (K₁) from first equirectangular image I_{EQN1} and a second set of key points (K₂) from second equirectangular image I_{EQN2}. In this disclosure, a key point is defined as a point in a two-dimensional (2D) image plane, which may be helpful in identifying a geometry of a scene or a geometry of an object included in the scene. The key point corresponds to a real-world point captured in at least one image (e.g., the first equirectangular image I_{EQN1}).

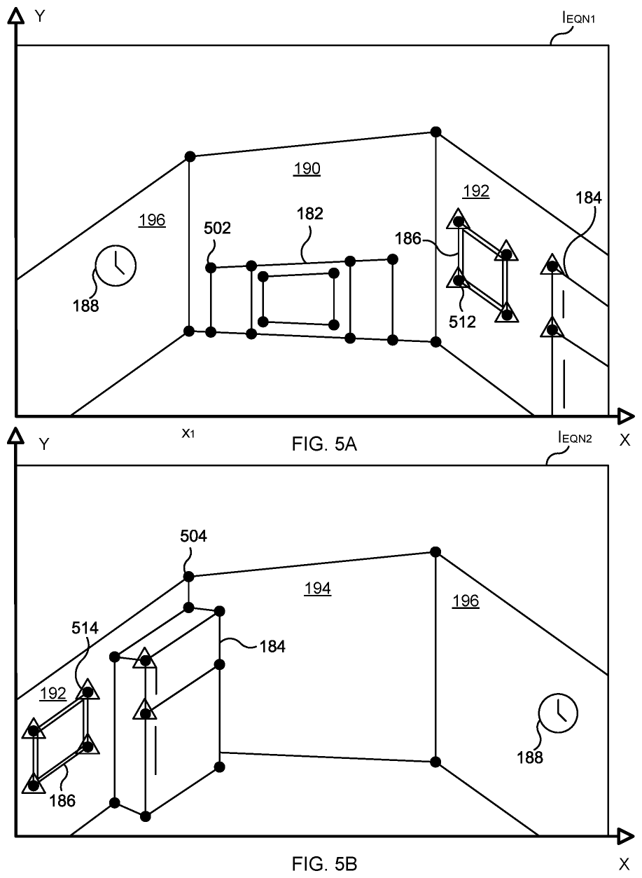

FIG. 5A shows examples of key points included in the first equirectangular image I_{EQN1} and FIG. 5B shows examples of key points included in the second equirectangular image I_{EQN2}. Note that, for simple illustration purpose, in FIGS. 5A and 5B, not all portions of the real environment captured in the first and second equirectangular images are shown in the figures, and curvatures of the lines included in the figures are omitted.

As shown in FIG. 5A, the first equirectangular image I_{EQN1} includes a first set of one or more key points 502 (the block circles shown in the figure). Similarly, as shown in FIG. 5B, the second equirectangular image I_{EQN2} includes a second set of one or more key points 504 (the block circles shown in the figure). In the examples of the first and second equirectangular images shown in FIGS. 5A and 5B, key points 502 and 504 identify corners of oven 182, corners of refrigerator 184, corners of picture frame 186, and/or corners of walls 190-196. As shown in FIGS. 5A and 5B, each of key points 502 and 504 may be defined with a pixel coordinate within each image. For example, in case the left bottom corner of each image is defined as an origin in an x-y coordinate system, each of key points 502 and 504 may be defined with a pixel coordinate (x, y).

Referring back to FIG. 4, after performing step s408, step s410 is performed. Step s410 comprises identifying a first set of matched key points (K₁*) 512 from the first set of key points (K₁) 502 and a second set of matched key points (K₂*) 514 from the second set of key points (K₂) 504.

In this disclosure, a matched key point is one of key points identified in step s408, and is defined as a point in a two-dimensional (2D) image plane, which corresponds to a real-world point captured in at least two different images. In this disclosure, a real-world point is any point in a real-world environment (e.g., kitchen 180), corresponding to a point on a physical feature (e.g., a housing) of an object included in the real-environment or a physical feature (e.g., a corner of a wall) of the real-world environment itself. For example, in FIGS. 5A and 5B, the four corners of picture frame 186 are captured in both first and second equirectangular images I_{EQN1} and I_{EQN2}. Thus, key points 502 and 504 corresponding to the four corners of picture frame 186 are matched key points 512 and 514.

Similarly, because two left side corners of the upper door of refrigerator 184 are captured in both the first and second equirectangular images I_{EQN1} and I_{EQN2}, key points 502 and 504 corresponding to the two left side corners of the upper door of refrigerator 184 are matched key points 512 and 514. Thus, key points 502 and 504 corresponding to the two left side corners of the upper door of refrigerator 184 are matched key points 512 and 514.

In a summary, the matched key points are key points corresponding to the real-world points that are “observed” from the captured multiple images from the same camera location.

Step s412 comprises identifying a set of three-dimensional (3D) points (a.k.a., “sparse point cloud”) corresponding to each set of key points described with respect to step s408. In this disclosure, a 3D point is defined as a point in a 3D virtual space, which corresponds to a key point described with respect to step s408. Here, the 3D point and the key point to which the 3D point corresponds identify the same real-world point.

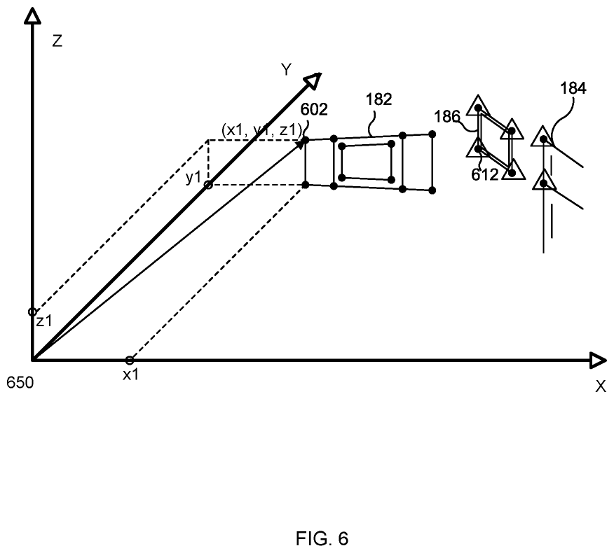

FIG. 6 shows examples of 3D points. As shown in the figure, 3D point 602 corresponds to the same real-world point corresponding to key points 502 and 504. More specifically, like key points 502 and 504, the 3D point 602 identifies corners of oven 182, corners of refrigerator 184, corners of picture frame 186, and/or corners of walls 190-196. The key difference between the key point and the 3D point is that they are defined in a different coordinate system. While the key point is defined on an image plane in a 2D coordinate system, the 3D point is defined in a virtual space in a 3D coordinate system. Thus, as shown in FIG. 6, the origin of the 3D coordinate system defining the 3D point is a point in a 3D virtual space. One example of the origin of the 3D coordinate system is a position in the virtual space, corresponding to a real world location where camera 102 was located when capturing the real environment.

Referring back to FIG. 4, after performing step s412, step s414 may be performed. Step s414 comprises selecting a set of matched 3D points from the 3D points identified in step s412. In this disclosure, a matched 3D point is one of 3D points identified in step s412, and is defined as a point in a 3D virtual space, which corresponds to a real-world point captured in the two different images. In a summary, 3D points (e.g., X₁) are 3D version of key points (e.g., K₁), and matched 3D points (e.g., X₁*) are 3D version of matched key points (e.g., K₁*).

Even though FIG. 4 shows that steps s408, s410, s412, and s414 are performed sequentially, in some embodiments, the steps may be performed in a different order. Also in other embodiments, at least some of the steps may be performed simultaneously.

In some embodiments, that steps s408, s410, s412, and s414 may be performed by running the Structure from Motion (SfM) technique such as COLMAP (described in https://colmap.github.io) and OpenMVG (described in https://github.com/openMVG/openMVG) on the equirectangular images obtained in step s406.

COLMAP only works on perspective images (a.k.a. “normal camera images”), so if COLMAP is to be used, I_{FC} needs to be converted into I_{PE} while since OpenMVG works on equirectangular images, in case OpenMVG is to be used, I_{FC} needs to converted into I_{EQN} instead. Whether to use COLMAP or OpenMVG can be determined based on various factors such as performance, cost, accuracy, licensing, preference.

Using the SfM technique, in addition to K, K*, X, and X*, additional data such as a camera pose can also be obtained.

Referring back to FIG. 4, after identifying first and second sets of matched key points (K₁*, K₂*) 512 and 514, step s416 may be performed. Step s416 comprises placing the first and second equirectangular images I_{EQN1} and I_{EQN2} into the same rotational space (e.g., one lens' rotational space). This step is needed because of the arrangements of first and second lenses 104 and 106. More specifically because first and second lenses 104 and 106 of camera 102 are directed toward different directions, the first and second equirectangular images I_{EQN1} and I_{EQN2} are in different rotational spaces, and thus step s412 is needed.

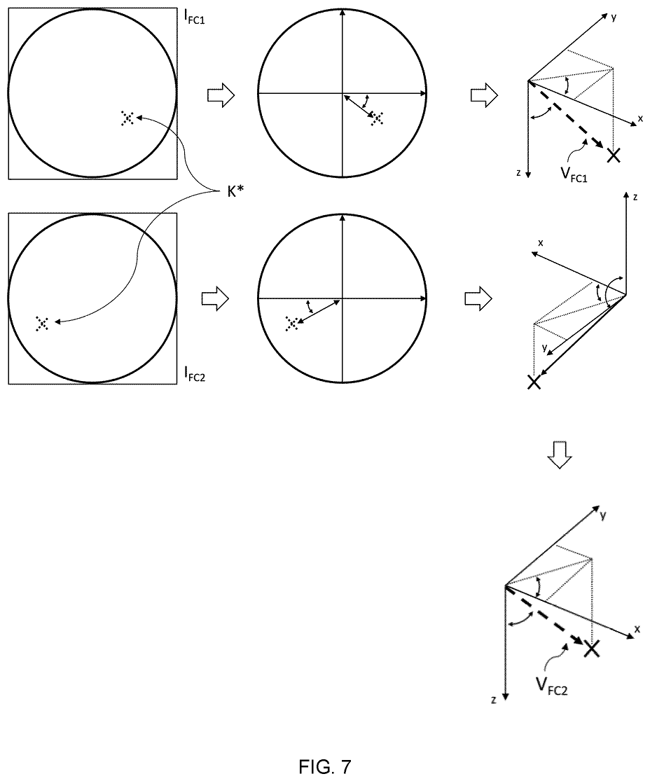

One way to place the first and second equirectangular images I_{EQN1} and I_{EQN2} into the same rotational space is placing second equirectangular image I_{EQN2} (or first equirectangular image I_{EQN1}) into the rotational space for first equirectangular image I_{EQN1} (or second equirectangular image I_{EQN2}). For example, the top three drawings of FIG. 7 show the rotational space of the first equirectangular image and the bottom left three drawings of FIG. 7 show the rotational space of the second equirectangular image. As illustrated in the bottom rightmost drawing of FIG. 7, one way to place the images into the same rotational space is by changing the rotational space of the second equirectangular image such that the two images are in the same rotational space. More specifically, in one example, in step s416, the axes of the second 3D rotational space may be rotated to be aligned with the axes of the first 3D rotational space such that the axes of the first and second 3D rotational spaces are now aligned.

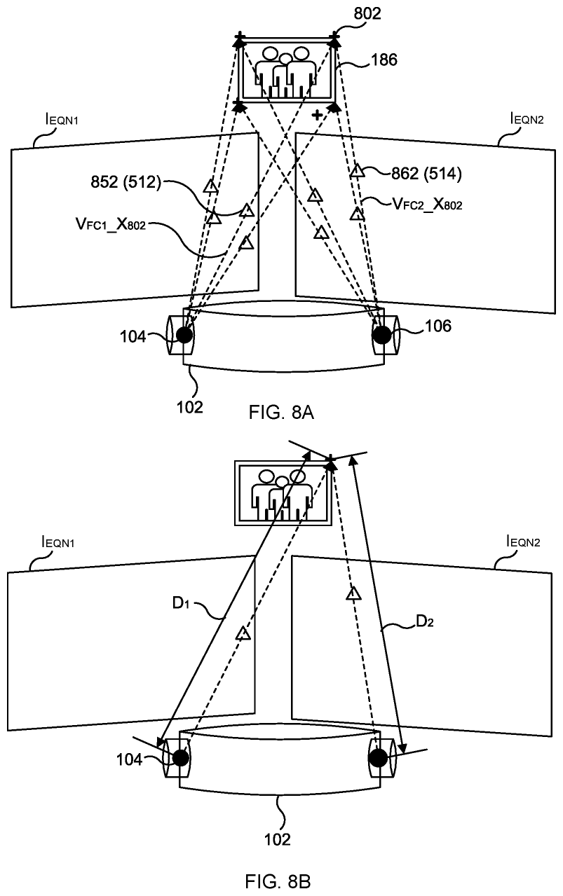

Step s418 comprises calculating a first directional vector (e.g., V_{FC1}_X₈₀₂ shown in FIG. 8A) from a reference point of first lens 104 to a first matched key point K₁* (e.g., 852 which is one of matched key points 512) and a second directional vector (e.g., V_{FC2}_X₈₀₂ shown in FIG. 8) from a reference point of second lens 106 to a second matched key point K₂* (e.g., 862 which is one of matched key points 514). As explained above, first matched key point K₁* (e.g., 852) and second matched key point K₂* (e.g., 862) correspond to the same real-world point (e.g., the top right corner of picture frame 186 shown in FIG. 1).

Step s420 comprises performing a triangulation in a 3D space using the first and second directional vectors to identify a real-world point corresponding to first matched key point 852 and second matched key point 862. In this disclosure, triangulation is a mathematical operation for finding an intersection point of two rays (e.g., vectors). In the field of computer vision, triangulation is a well understood concept, and thus detailed explanation as to how the triangulation is performed is omitted in this disclosure.

FIG. 8A illustrates how step s420 can be performed. In FIG. 8A, first directional vector V_{FC1}_X₈₀₂ and second directional vector V_{FC2}_X₈₀₂ are determined. First directional vector V_{FC1}_X₈₀₂ is a vector from first lens 104 towards first matched key point 852 and second directional vector V_{FC2}_X₈₀₂ is a vector from second lens 106 towards second matched key point 862. As shown in FIG. 8A, first matched key point 852 and second matched key point 862 correspond to the same real-world physical point (i.e., the top right corner of picture frame 186).

Via step s420, an intersection of first directional vector V_{FC1}_X₈₀₂ and second directional vector V_{FC2}_X₈₀₂ is determined. In FIG. 8A, the intersection corresponds to a point 802. Here, point 802 corresponds to a real-world physical location (e.g., the physical location of the top right corner of picture frame 186) corresponding to first and second matched key points 852 and 862.

Referring back to FIG. 4, after finding the intersection (i.e., point 802), step s422 is performed. Step s422 comprises calculating a first distance (e.g., D₁ shown in FIG. 8B) between first lens 104 and point 802, and a second distance (e.g., D₂ shown in FIG. 8B) between second lens 106 and point 802.

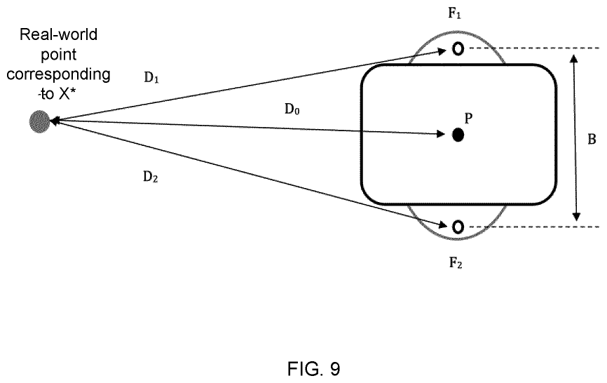

Step s424 comprises calculating an actual physical distance (e.g., Do shown in FIG. 9) between the center of camera (e.g., P shown in FIG. 9) and real-world physical point 802 using first and second distances (e.g., D₁ and D₂) calculated in step s422. Any known mathematical operations can be used for calculating Do using the first and second distances.

Since the SfM technique that is used to generate the 3D points X, X* generates an estimate of P (for each capture position) relative to some arbitrarily chosen 0-point (i.e., center of the coordinate system), there is an offset between the location of camera 102 and the arbitrarily chosen 0-point. In order to correct the scale correctly, the offset needs to be removed by re-centering the coordinate system onto the camera position.

Thus, step s426 may be performed. Step s426 comprises converting an initial coordinate X*(x*,y*,z*) of each of the matched 3D points (e.g., 602 shown in FIG. 6) into a corrected coordinate X*ₒ(x*ₒ,y*ₒ,z*ₒ) by moving the origin of the coordinate system of the 3D reconstructed space from reference point 650 to location P of camera 102 (shown in FIG. 1). For example, if the initial coordinate of the matched 3D point 602 is (x*,y*,z*) in a coordinate system having reference point 650 as the origin, the converted coordinate of the matched 3D point 602 is (x*ₒ,y*ₒ,z*ₒ) in a coordinate system having the location P as the origin.

After determining the corrected coordinate X*(x*ₒ,y*ₒ,z*ₒ) of each of the matched 3D points 602, in step s428, a distance D₀(X*ₒ) between the corrected coordinate X*ₒ(x*ₒ,y*ₒ,z*ₒ) of each of the matched 3D points and the new origin of the coordinate system (i.e., the location P of camera 102) is calculated. In other words, D₀(X*ₒ) may be equal to or may be based on

$$\sqrt{{x}_{o}^{* 2} + {y}_{0}^{* 2} + {z}_{o}^{* 2}} .$$

Step s430 comprises calculating a local scale factor S* indicating a ratio of virtual dimension(s) of the reconstructed 3D space to real world dimension(s) of the reconstructed 3D space. In some embodiments, the local scale factor S* may be obtained based on

$$\frac{{D}_{0} ( {X}_{o}^{*} )}{{D}_{0} ( {X}^{*} )} .$$

For example,

$${S}^{*} = \frac{{D}_{0} ( {X}_{o}^{*} )}{{D}_{0} ( {X}^{*} )} .$$

As discussed above, there are more than one matched 3D points (e.g., 602 shown in FIG. 6). For example, as shown in FIG. 6, there are at least six matched 3D points for picture frame 186. Thus, in some embodiments, steps s418-s430 may be calculated for each of the plurality of matched 3D points. In those embodiments, multiple local scale factors S* may be obtained as a result of performing step s430.

In such embodiments, step s432 may be provided. In step s432, a single general scale factor (a.k.a., “absolute scale factor” or “global scale factor”) for all matched 3D points may be calculated based on the obtained multiple local scale factors. For example, an absolute scale factor may be calculated based on (or may be equal to) an average of multiple locale scale factors. The average may be either a non-weighted average (where

$$\frac{{\sum }_{i = 1}^{N} {S}_{i} *}{N} ,$$

where N is the number of local scale factors Sᵢ*) or a weighted average.

In case the average is a weighted average of the multiple local scale factors, the weight of each local scale factor associated with each 3D point may be determined based on a confidence value of each 3D point. This confidence value of each 3D point may be generated by the SfM technique and may indicate or estimate the level of certainty that the 3D point is in the correct position in the 3D virtual space.

In one embodiment, the confidence value of a 3D point may indicate the number of key points identifying the 3D point. For example, if kitchen 180 shown in FIG. 1 is captured by camera 102 at two different locations, then two different images would be generated—a first image having a first group of key points and a second image having a second group of key points. Let's assume a scenario where (i) the first group of key points includes a first key point identifying a top left corner of picture frame 186 and a second key point identifying a bottom right corner of refrigerator 184 and (ii) the second group of key points includes a third key point identifying the top left corner of picture frame 186 but does not include any key point identifying the bottom right corner of refrigerator 184. In such scenario, because the top left corner of picture frame 186 is identified by two key points while the bottom right corner of refrigerator 184 is identified by just one key point, the confidence value of the 3D point corresponding to the top left corner of picture frame 186 would be higher than the confidence value of the 3D point corresponding to the bottom left corner of refrigerator 184.

Absolute scale factor S obtained in step s432 may be used to bring an absolute scale to the 3D constructed space. For example, as discussed above, there may be a scenario where a user wants to measure the real-world length L (shown in FIG. 1) between first wall 190 and the left side of refrigerator 184. Using absolute scale factor S, the length L can be calculated. For example, the length L may be equal to or may be calculated based on L₀/S, where L₀ (shown in FIG. 3) is the length between first wall 190 and the left side of refrigerator 184 in the 3D reconstructed space.

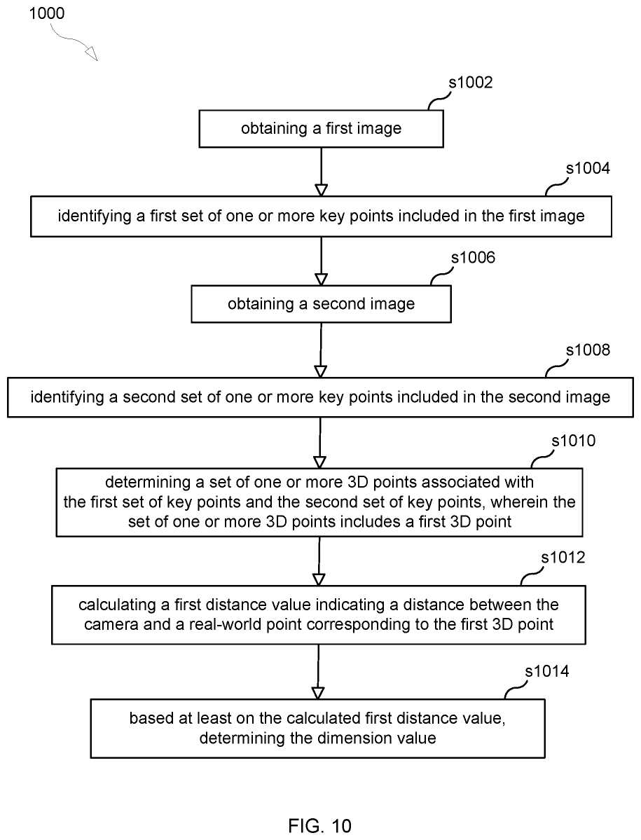

FIG. 10 shows a process 1000 for determining a dimension value indicating a physical dimension of a three-dimensional, 3D, space according to some embodiments. Process 1000 may begin with steps 1002. Step s1002 comprises obtaining a first image, wherein the first image is generated using a first lens of a camera. Step s1004 comprises identifying a first set of one or more key points included in the first image. Step s1006 comprises obtaining a second image, wherein the second image is generated using a second lens of the camera. Step s1008 comprises identifying a second set of one or more key points included in the second image. Step s1010 comprises determining a set of one or more 3D points associated with the first set of key points and the second set of key points, wherein the set of one or more 3D points includes a first 3D point. Step s1012 comprises calculating a first distance value indicating a distance between the camera and a real-world point corresponding to the first 3D point. Step s1014 comprises, based at least on the calculated first distance value, determining the dimension value.

In some embodiments, generating the first image comprises capturing a first fisheye image using the first lens of the camera and converting the captured first fisheye image into the first image, generating the second image comprises capturing a second fisheye image using the second lens of the camera and converting the captured second fisheye image into the second image, and each of the first image and the second image is an equidistant image or an equirectangular image.

In some embodiments, the method further comprises identifying a first subset of one or more key points from the first set of key points and identifying a second subset of one or more key points from the second set of key points, wherein a first key point included in the first subset is matched to a second key point included in the second subset, and the first 3D point maps to the first key point and the second key point.

In some embodiments, the method further comprises determining a first directional vector having a first direction, wherein the first direction is from a first reference point of the first lens of the camera to one key point included in the first set of key points; and determining a second directional vector having a second direction, wherein the second direction is from a second reference point of the second lens of the camera to one key point included in the second set of key points.

In some embodiments, the method further comprises performing a triangulation process using the first directional vector, the second directional vector, and a baseline between the first and second reference points, thereby determining an intersection point of the first directional vector and the second directional vector, wherein the real-world point is the intersection point.

In some embodiments, the method further comprises calculating a second distance value indicating a distance between the real-world point and the first lens of the camera; and calculating a third distance value indicating a distance between the real-world point and the second lens of the camera, wherein the first distance value is calculated using the second distance value and the third distance value.

In some embodiments, the distance between the real-world point and the camera is a distance between the real-world point and a reference point in the camera, and the reference point is located between a location of the first lens and a location of the second lens.

In some embodiments, the method further comprises converting original coordinates of said one or more 3D points into converted coordinates, wherein the original coordinates are in a first coordinate system, the converted coordinates are in a second coordinate system, a center of the first coordinate system is not a reference point of the camera, and a center of the second coordinate system is the reference point of the camera.

In some embodiments, the converted coordinates of said one or more 3D points include a first converted coordinate of the first 3D point, and the method further comprises calculating a first reference distance value indicating a distance between the reference point of the camera and the first converted coordinate of the first 3D point.

In some embodiments, the method further comprises determining a scaling factor value based on a ratio of the first distance value and the first reference distance value, wherein the dimension value is determined based on the scaling factor value.

In some embodiments, the method further comprises i) calculating a distance value indicating a distance between the reference point of the camera and a real world point mapped to each of the original coordinates of said one or more 3D points; ii) calculating a reference distance value indicating a distance between the reference point of the camera and each of the converted coordinates of said one or more 3D points; iii) determining, for each of said one or more 3D points, a scaling factor value based on a ratio of the distance value obtained in step i) and the reference distance value obtained in step ii); and iv) calculating an average of the scaling factors of said one or more 3D points.

In some embodiments, the dimension value is determined based on the average of the scaling factors.

In some embodiments, the method further comprises displaying at least a part of the 3D space with an indicator indicating the physical dimension.

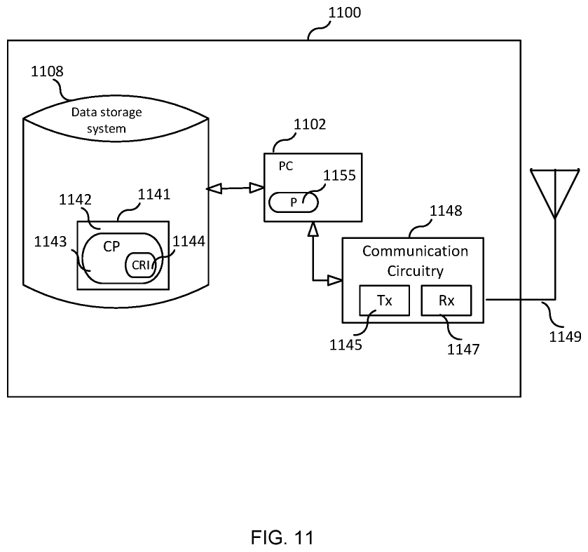

FIG. 11 shows an apparatus 1100 capable of performing all steps included in process 400 (shown in FIG. 4) or at least some of the steps included in process 400 (shown in FIG. 4). Apparatus 1100 may be any computing device. Examples of apparatus 1100 include but are not limited to a server, a laptop, a desktop, a tablet, a mobile phone, etc. As shown in FIG. 11, the apparatus may comprise: processing circuitry (PC) 1102, which may include one or more processors (P) 1155 (e.g., one or more general purpose microprocessors and/or one or more other processors, such as an application specific integrated circuit (ASIC), field-programmable gate arrays (FPGAs), and the like); communication circuitry 1148, which is coupled to an antenna arrangement 1149 comprising one or more antennas and which comprises a transmitter (Tx) 1145 and a receiver (Rx) 1147 for enabling the apparatus to transmit data and receive data (e.g., wirelessly transmit/receive data); and a local storage unit (a.k.a., “data storage system”) 1108, which may include one or more non-volatile storage devices and/or one or more volatile storage devices. In some embodiments, the apparatus may not include the antenna arrangement 1149 but instead may include a connection arrangement needed for sending and/or receiving data using a wired connection. In embodiments where PC 1102 includes a programmable processor, a computer program product (CPP) 1141 may be provided. CPP 1141 includes a computer readable medium (CRM) 1142 storing a computer program (CP) 1143 comprising computer readable instructions (CRI) 1144. CRM 1142 may be a non-transitory computer readable medium, such as, magnetic media (e.g., a hard disk), optical media, memory devices (e.g., random access memory, flash memory), and the like. In some embodiments, the CRI 1144 of computer program 1143 is configured such that when executed by PC 1102, the CRI causes the apparatus to perform steps described herein (e.g., steps described herein with reference to the flow charts). In other embodiments, the apparatus may be configured to perform steps described herein without the need for code. That is, for example, PC 1102 may consist merely of one or more ASICs. Hence, the features of the embodiments described herein may be implemented in hardware and/or software.

1. A method of determining a dimension value indicating a physical dimension of a three-dimensional, (3D) space, the method comprising:
obtaining a first image, wherein the first image is generated using a first lens of a camera;
identifying a first set of one or more key points included in the first image;
obtaining a second image, wherein the second image is generated using a second lens of the camera;
identifying a second set of one or more key points included in the second image;
determining a set of one or more 3D points associated with the first set of key points and the second set of key points, wherein the set of one or more 3D points includes a first 3D point;
calculating a first distance value indicating a distance between the camera and a real-world point corresponding to the first 3D point; and
based at least on the calculated first distance value, determining the dimension value.

2. The method of claim 1, wherein
generating the first image comprises capturing a first fisheye image using the first lens of the camera and converting the captured first fisheye image into the first image,
generating the second image comprises capturing a second fisheye image using the second lens of the camera and converting the captured second fisheye image into the second image, and
each of the first image and the second image is an equidistant image or an equirectangular image.

3. The method of claim 1, further comprising:
identifying a first subset of one or more key points from the first set of key points; and
identifying a second subset of one or more key points from the second set of key points, wherein
a first key point included in the first subset is matched to a second key point included in the second subset, and
the first 3D point maps to the first key point and the second key point.

4. The method of claim 1, the method comprising:
determining a first directional vector having a first direction, wherein the first direction is from a first reference point of the first lens of the camera to one key point included in the first set of key points; and
determining a second directional vector having a second direction, wherein the second direction is from a second reference point of the second lens of the camera to one key point included in the second set of key points.

5. The method of claim 4, the method comprising:
performing a triangulation process using the first directional vector, the second directional vector, and a baseline between the first and second reference points, thereby determining an intersection point of the first directional vector and the second directional vector, wherein
the real-world point is the intersection point.

6. The method of claim 1, further comprising:
calculating a second distance value indicating a distance between the real-world point and the first lens of the camera; and
calculating a third distance value indicating a distance between the real-world point and the second lens of the camera, wherein
the first distance value is calculated using the second distance value and the third distance value.

7. The method of claim 1, wherein
the distance between the real-world point and the camera is a distance between the real-world point and a reference point in the camera, and
the reference point is located between a location of the first lens and a location of the second lens.

8. The method of claim 1, further comprising:
converting original coordinates of said one or more 3D points into converted coordinates, wherein
the original coordinates are in a first coordinate system,
the converted coordinates are in a second coordinate system,
a center of the first coordinate system is not a reference point of the camera, and
a center of the second coordinate system is the reference point of the camera.

9. The method of claim 8, wherein
the converted coordinates of said one or more 3D points include a first converted coordinate of the first 3D point, and
the method further comprises calculating a first reference distance value indicating a distance between the reference point of the camera and the first converted coordinate of the first 3D point.

10. The method of clam 9, further comprising:
determining a scaling factor value based on a ratio of the first distance value and the first reference distance value, wherein
the dimension value is determined based on the scaling factor value.

11. The method of claim 10, wherein the method further comprises:
i) calculating a distance value indicating a distance between the reference point of the camera and a real world point mapped to each of the original coordinates of said one or more 3D points;
ii) calculating a reference distance value indicating a distance between the reference point of the camera and each of the converted coordinates of said one or more 3D points;
iii) determining, for each of said one or more 3D points, a scaling factor value based on a ratio of the distance value obtained in step i) and the reference distance value obtained in step ii); and
iv) calculating an average of the scaling factors of said one or more 3D points.

12. The method of claim 11, wherein the dimension value is determined based on the average of the scaling factors.

13. The method of claim 1, further comprising:
displaying at least a part of the 3D space with an indicator indicating the physical dimension.

14. A non-transitory computer readable storage medium storinga computer program comprising instructions which when executed by processing circuitry cause the processing circuitry for configuring an apparatus to perform the method of claim 1.

15. (canceled)

16. An apparatus for determining a dimension value indicating a physical dimension of a three-dimensional, (3D) space, the apparatus comprising:
a processing circuitry; and
a memory containing instructions for configuring the apparatus to:
obtain a first image, wherein the first image is generated using a first lens of a camera;
identify a first set of one or more key points included in the first image;
obtain a second image, wherein the second image is generated using a second lens of the camera;
identify a second set of one or more key points included in the second image;
determine a set of one or more 3D points associated with the first set of key points and the second set of key points, wherein the set of one or more 3D points includes a first 3D point;
calculate a first distance value indicating a distance between the camera and a real-world point corresponding to the first 3D point; and
based at least on the calculated first distance value, determine the dimension value.

17. The apparatus of claim 16, wherein
generating the first image comprises capturing a first fisheye image using the first lens of the camera and converting the captured first fisheye image into the first image,
generating the second image comprises capturing a second fisheye image using the second lens of the camera and converting the captured second fisheye image into the second image, and
each of the first image and the second image is an equidistant image or an equirectangular image.

18. The apparatus of claim 16, wherein the apparatus is further configured to:
identify a first subset of one or more key points from the first set of key points; and
identify a second subset of one or more key points from the second set of key points, wherein
a first key point included in the first subset is matched to a second key point included in the second subset, and
the first 3D point maps to the first key point and the second key point.

19. The apparatus of claim 16, wherein the apparatus is further configured to:
determine a first directional vector having a first direction, wherein the first direction is from a first reference point of the first lens of the camera to one key point included in the first set of key points; and
determine a second directional vector having a second direction, wherein the second direction is from a second reference point of the second lens of the camera to one key point included in the second set of key points.

20. The apparatus of claim 19, wherein the apparatus is further configured to:
perform a triangulation process using the first directional vector, the second directional vector, and a baseline between the first and second reference points, thereby determining an intersection point of the first directional vector and the second directional vector, wherein
the real-world point is the intersection point.

21. The apparatus of claim 16, wherein the apparatus is further configured to:
calculate a second distance value indicating a distance between the real-world point and the first lens of the camera; and
calculate a third distance value indicating a distance between the real-world point and the second lens of the camera, wherein
the first distance value is calculated using the second distance value and the third distance value.

22-29. (canceled)
